(19) United States
(12) Patent Application Publication
(10) Pub. No.: US 2013/0141460 A1
(43) Pub. Date: Jun. 6, 2013

(54) METHOD AND APPARATUS FOR VIRTUAL INCIDENT REPRESENTATION

(71) Applicants: Yana Kane-Esrig, Madison, NJ (US); Michael Wengrovitz, Concord, MA (US)

(72) Inventors: Yana Kane-Esrig, Madison, NJ (US); Michael Wengrovitz, Concord, MA (US)

(21) Appl. No.: 13/309,733

(22) Filed: Dec. 2, 2011

(51) Int. Cl. G09G 5/377

(52) U.S. Cl. 345/633

(57) ABSTRACT

A virtual incident representation capability is disclosed. The virtual incident representation capability is configured to represent a real world incident within a virtual world representation to provide thereby a virtual incident representation of the real world incident, which may be made available to people involved in the handling of the real world incident (e.g., operators at the safety answering point to which the real world incident is reported, responders in the field who have or will respond to the site of the real world incident, and the like). The virtual incident representation approximates the actual events of the real world incident in both space and time, and also may indicate the degree of certainty of at least a portion of the information included within the virtual incident representation. The virtual incident representation may be dynamic and interactive.

### TECHNICAL FIELD

The invention relates generally to communication networks and, more specifically but not exclusively, to supporting incident reporting services via communication networks.

### BACKGROUND

In existing communication networks, there are incident reporting services which support reporting of incidents to Public Safety Answering Points (PSAPs). Disadvantageously, however, such incident reporting services typically rely upon operators to listen to information from people calling to report incidents and to relay the reported information to the first responders and others involved in the management of the incident.

### SUMMARY

Various deficiencies in the prior art are addressed by embodiments for providing a virtual world representation of a real world incident.

In one embodiment, an apparatus includes a processor and a memory, where the processor is configured to receive incident information related to a real world incident and directed toward a safety answering point where the incident information includes a plurality of information types, and combine the incident information with a virtual representation of a portion of the real world associated with a location of the real world incident to provide thereby a virtual incident representation of the real world incident.

In one embodiment, a computer-readable storage medium stores instructions which, when executed by a computer, cause the computer to perform a method which includes receiving incident information related to a real world incident and directed toward a safety answering point where the incident information includes a plurality of information types, and combining the incident information with a virtual representation of a portion of the real world associated with a location of the real world incident to provide thereby a virtual incident representation of the real world incident.

In one embodiment, a method includes receiving incident information related to a real world incident and directed toward a safety answering point where the incident information includes a plurality of information types, and combining the incident information with a virtual representation of a portion of the real world associated with a location of the real world incident to provide thereby a virtual incident representation of the real world incident.

### BRIEF DESCRIPTION OF THE DRAWINGS

The teachings herein can be readily understood by considering the following detailed description in conjunction with the accompanying drawings, in which:

FIG. 1 depicts a high-level block diagram of an environment configured to provide a dynamic, interactive, virtual representation of a real world incident;

FIG. 2 depicts one embodiment of a method for providing a virtual incident representation of a real world incident;

FIG. 3 depicts one embodiment of a method for using a virtual incident representation of a real world incident to perform one or more management functions;

FIGS. 4A and 4B depict an example illustrating an initial virtual incident representation and modification of the initial virtual incident representation over time to provide thereby a later virtual incident representation; and

FIG. 5 depicts a high-level block diagram of a computer suitable for use in performing functions described herein.

To facilitate understanding, identical reference numerals have been used, where possible, to designate identical elements that are common to the figures.

### DETAILED DESCRIPTION

In general, a virtual incident representation capability is depicted and described herein, although various other capabilities also may be presented herein.

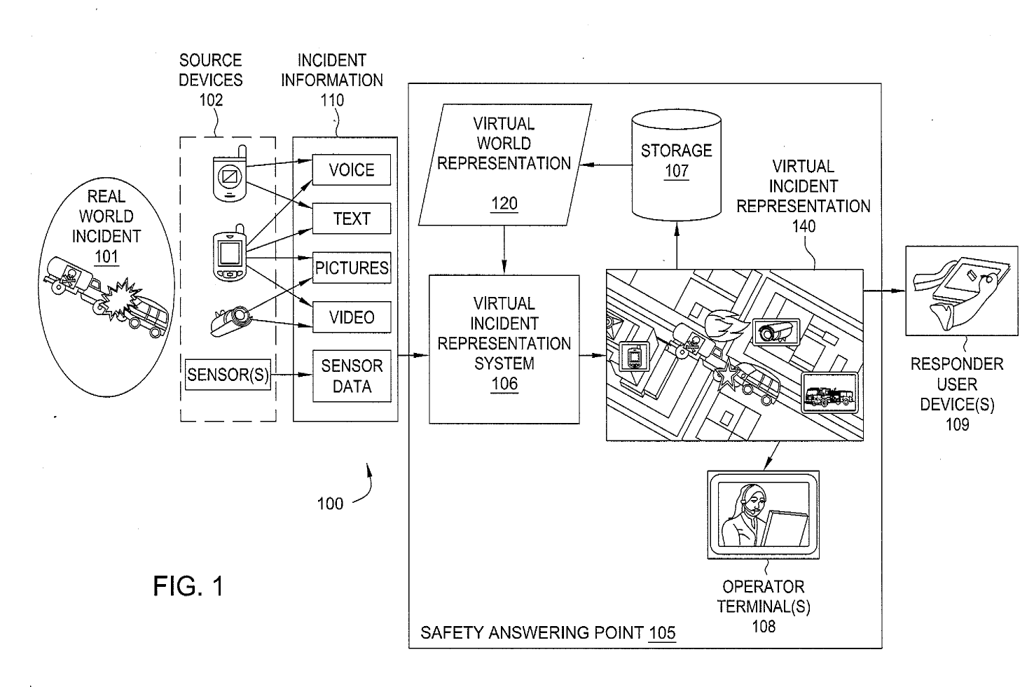

In at least some embodiments, a real world incident reported to a safety answering point (e.g., a Public Safety Answering Point (PSAP), a private safety answering point, and the like) is represented via reconstruction of the real world incident in a virtual world, providing thereby a virtual incident representation which may then be made available to people involved in the handling of the real world incident (e.g., operators at the safety answering point, responders in the field who have or will respond to the site of the real world incident, and the like, as well as various combinations thereof). In at least some embodiments, the virtual incident representation approximates the actual events of the real world incident in both space and time, and also may indicate the degree of certainty of at least a portion of the information included within the virtual incident representation. In at least some embodiments, the virtual incident representation is dynamic and interactive. These and various other embodiments may be better understood by way of reference to FIGS. 1-5 depicted and described herein.

FIG. 1 depicts a high-level block diagram of an environment configured to provide a dynamic, interactive virtual world representation of a real world incident.

As depicted in FIG. 1, a real world incident 101 occurs. The real world incident 101 may be any type of incident which may be reported to a safety answering point. For example, real world incident 101 may be a traffic accident, a robbery, a fire, a home invasion, a flood, an earthquake, a tornado, a hurricane, and the like. For example, types of safety answering points to which incidents may be reported may include Public Safety Answering Points (e.g., E911 PSAPs, federal PSAPs, and the like), private safety answering points (e.g., Private Emergency Call Centers and the like), and the like. It is noted that the real world incident 101 may be on any scale, from a local incident (e.g., a car accident, a fire, a crime, and the like) to a wider-scale incident (e.g., a robbery and associated high-speed car chase through a portion of a town or city, a flood impacting an entire town or city, an earthquake or other natural disaster impacting a larger geographic area (e.g., county level, state level, national level, and so forth), and the like). VIRS 106

As further depicted in FIG. 1, real world incident 101 is reported to a safety answering point. More specifically, source devices 102 direct incident information 110 associated with real world incident 101 to safety answering point 105. The safety answering point 105 includes a virtual incident representation system (VIRS) 106, a storage 107, and one or more operator terminals 108. The VIRS 106 is configured to receive the incident information 110 from source devices 102, access a virtual representation of at least a portion of the real world associated with the location of the real world incident 101 (denoted herein as a virtual world representation 120 or virtual world 120) from storage 107, and combine the incident information 110 with the virtual world representation 120 to provide thereby a virtual representation of the real world incident 101 which is denoted herein as a virtual incident representation 140. The VIRS 106 is configured to provide the virtual incident representation 140 to one of more of storage 107, one or more of the operator terminals 108 (e.g., such that it may be viewed by one or more operators working on the real world incident 101), one or more responder user devices 109 of responders dispatched for on-site handling of the real world incident 101, and the like. It will be appreciated that virtual world representation 140 may be handled in any other suitable manner (e.g., distributed to other types of end users, transmitted over communication networks for delivery to other systems and/or remote storage, and the like, as well as various combinations thereof).

The source devices 102 are configured to receive and/or capture incident information 110 related to real world incident 101 and to provide the incident information 110 to VIRS 106 of safety answering point 105. The source devices 102 may be configured to provide the received/captured incident information 110 to VIRS 106 of safety answering point 105 via one or more communication network which are omitted for purposes of clarity (e.g., via one or more of a public data network, a private data network, a cellular network, and the like, as well as various combinations thereof). The source devices 102 are configured to receive/capture and provide various types of information, such as voice, text, image-based content, sensor data, and the like, as well as various combinations thereof. For example, the source devices 102 may include landline phones, cellular phones, smartphones, computers, laptops, video cameras, sensors, and the like.

The source devices 102 may be located at or near the location of the real world incident 101 when providing incident information 110 to safety answering point 105 (e.g., a person calls safety answering point 105 and begins describing the scene of the real world incident 101, a person takes pictures and then sends them to safety answering point 105 while still located in the vicinity of the real world incident, and the like) and/or may be remote from the location of the real world incident 101 when providing incident information 110 to safety answering point 105 (e.g., a person witnesses a dangerous situation but waits until he or she has moved to a safe location before calling the safety answering point 105 to report the real world incident 101, a person records video from scene of the real world incident 101 but has moved away from the scene before sending the video to the safety answering point 105, and the like).

The VIRS 106, as noted above, is configured to provide the virtual incident representation 140 of the real world incident 101 by combining incident information 110 related to the real world incident 101 with the virtual world representation 120 of a portion of the real world associated with real world incident 101. The incident information 110, virtual world representation 120, and virtual incident representation 140 are described in additional detail below.

The VIRS 106 receives incident information 110 related to the real world incident 101. The incident information 110 may include one or more of voice conversations, voice messages, text messages, pictures, videos, sensor data, and the like, as well as various combinations thereof. The incident information 110 may be received from any suitable sources of such information. For example, various portions of incident information 110 may be received from human sources of information (e.g., members of the public contacting the safety answering point 105 from the scene of real world incident 101 to report real world incident 101 and/or to provide details regarding the real world incident 101, emergency responders providing information from the scene of real world incident 101, and the like, as well as various combinations thereof) via various types of communications devices (e.g., landline phones, cellular phones, smartphones, laptops, and the like). For example, incident information 110 may be received from non-human sources of information at or near the scene of real world incident 101 (e.g., street cameras, sensors embedded in vehicles and/or other objects, and the like, as well as various combinations thereof). For example, incident information 110 may be received from non-human sources of information remote from the scene of real world incident 101 (e.g., systems, databases, and the like, as well as various combinations thereof). It is noted that the devices from which incident information 110 is received also may be considered to be the sources of the incident information 110. At least some such sources of incident information 110 are depicted as source devices 102 of FIG. 1.

The VIRS 106 is configured to access the virtual world representation 120. The virtual world representation 120 may be provided in two dimensions or three dimensions (although it is primarily depicted and described herein within the context of embodiments using three dimensional representations). The virtual world representation 120 may include natural and/or manmade features, objects, and the like (e.g., depictions of geographical terrain, depictions of roads and buildings, depictions of objects, and the like, as well as various combinations thereof). Although primarily depicted and described with respect to embodiments in which the VIRS 106 accesses the virtual world representation 120 from a local storage of the safety answering point 105 (illustratively, storage 107), it is noted that VIRS 106 may accesses the virtual world representation 120 from any suitable source (e.g., from local memory of VIRS 106, from one or more remote systems via a communication network, and the like, as well as various combinations thereof).

The VIRS 106, as noted above, is configured to generate the virtual incident representation 140 by combining virtual world representation 120 of the location of the real world incident 101 and incident information 110 related to the real world incident 101. As a result, the virtual incident representation 140 of the real world incident 101 is a rendering of the real world (e.g., location in space with the various relevant natural and manmade features and objects at that location in the real world, such as lakes, rivers, mountains, roads, buildings, and the like) which includes representations of various characteristics related to the real world incident 101 (e.g., events, conditions, and the like).

The VIRS 106 is configured to generate, maintain, and update the virtual incident representation 140. The VIRS 106 receives the incident information 110 and the virtual world representation 120, and maps the incident information 110 onto the virtual world representation 120 to provide thereby the virtual incident representation 140. In this manner, the virtual incident representation 140 is a virtual representation of real world incident 101 that is presented within the context of virtual world representation 120 while including the incident information 110 associated with real world incident 101.

The VIRS 106 is configured to update virtual incident representation 140 under various conditions. The VIRS 106 is configured to update virtual incident representation 140 as incident information 110 that is associated with real world incident 101 is received. The VIRS 106 is configured to update virtual incident representation 140 when a portion of the virtual world representation 120 that is associated with real world incident 101 changes. The VIRS 106 is configured to support interaction with virtual incident representation 140. In this sense, virtual incident representation 140 provides a dynamic, interactive representation real world incident 101 within the context of the virtual world representation 120 of the real world location or region in which the real world incident 101 is occurring and/or has occurred.

The virtual incident representation 140 may include a reconstruction of the events of the real world incident 101. The reconstruction of the events of the real world incident 101 may include information on the location of, details regarding, and interaction among people, objects, and/or processes involved in and/or related to the real world incident 101. The reconstruction of the events of the real world incident 101 may be organized in a timed sequence according to reconstruction of the timeline of the events (e.g., reconstructed using various portions of the incident information 110).

In one embodiment, various people of interest (e.g., victims, suspects, emergency responders, and the like) may be represented using avatars, which can move and interact in the virtual incident representation 140. The avatars representing the people may reflect the amount of information available about the people (e.g., location, physical characteristics, and the like, as well as various combinations thereof). As more information becomes available about a given person (e.g., via incident information 110 received at the VIRS 106), the associated avatar may be updated to reflect the new information (e.g., the avatar acquires features and details that make it look less like a generic symbol and more like the actual person). For example, the avatar may initially be represented as a generic male avatar without any distinguishing characteristics where initial reports included in incident information 110 only indicate the gender of the person, the avatar may then be updated to include a dark hair color in response to subsequent reports indicating that the person has dark hair, and so forth, such that the avatar becomes more detailed as more detailed information is received as part of the incident information 110.

In one embodiment, various objects of interest (e.g., buildings, vehicles, equipment, and the like) may be represented using avatars which, in some cases (e.g., vehicles, equipment, and the like) can move and interact in the virtual incident representation 140. The avatars representing the objects may reflect the amount of information available about the objects (e.g., location, physical characteristics, and the like, as well as various combinations thereof). As more information becomes available about a given object (e.g., via incident information 110 received at the VIRS 106), the associated avatar may be updated to reflect the new information (e.g., the avatar acquires features and details that make it look less like a generic symbol and more like the actual object). For example, the avatar may initially be represented as a generic vehicle avatar without any distinguishing characteristics where initial reports included in incident information 110 only indicate the presence of a vehicle (e.g., outline of a box with wheels so as not to falsely imply a particular type of vehicle, color, or any other characteristic which is not yet known), the avatar may then be updated to take the shape of a pickup truck in response to subsequent reports indicating that the vehicle is a pickup truck (e.g., still using an outline of a pickup truck so as not to falsely indicate a particular color or any other characteristic which is not yet known), the avatar may then be further updated to be red in response to subsequent reports indicating that the vehicle was red, and so forth, such that the avatar becomes more detailed as more detailed information is received as part of the incident information 110.

In one embodiment, various processes of interest may be represented in the virtual world representation. For example, processes of interest may include natural processes (e.g., fires, flooding, and the like) and/or manmade processes (e.g., car chases, hostage situations, and the like).

The VIRS 106 is configured to generate, maintain, and update the virtual incident representation 140 of the real world incident 101 over time as the state of the real world incident 101 changes. This enables the end user to view the virtual incident representation 140 over any time scale. This may enable the end user to view snapshots of the virtual incident representation 140 at specific points in time and/or to view the virtual incident representation 140 over periods of time. For example, this enables the end user to view the current state of the virtual incident representation 140, view any portion of the virtual incident representation 140 during any past time (e.g., at a specific time in the past, from the time the virtual incident representation 140 was first formed up to the current time, and the like), view any portion of the virtual incident representation 140 at any future time (e.g., at a specific time in the future, from the current time up to any suitable time in the future, and the like), and the like, as well as various combinations thereof.

In one embodiment, for example, such capabilities may include support for picture-like renderings of the virtual incident representation 140 at various times. For example, am end user may request a current snapshot of the state of virtual incident representation 140, a snapshot of the state of virtual incident representation 140 at a specific time in the past (e.g., to see the initial starting point of a vehicle at a particular time in the past, to see the initial stages of a fire which has since spread, and the like), a snapshot of a forecast of the state of virtual incident representation 140 at a specific time in the future (e.g., to see the expected location of a vehicle at a particular time in the future, to see the expected extent of a fire at a particular time in the future, and the like), and the like.

In one embodiment, for example, such capabilities may include support for video-like renderings of virtual incident representation 140 at various times. For example, an end user may watch a video showing how the state of virtual incident representation 140 evolved over a particular range of time in the past, an end user may watch a video showing how the state of virtual incident representation 140 is forecasted to evolve over a particular range of time in the future (e.g., to see the expected route followed by a vehicle over a particular range of time in the future, to see the expected manner in which a fire will spread over a particular range of time in the future, and the like), and the like, as well as various combinations thereof (e.g., a video showing both the state of the virtual incident representation in the past and as forecast for the future). In one embodiment, video-like renderings of the virtual incident representation 140 may support trick-play functions whereby an end user may rewind and fast-forward the rendering of the virtual incident representation 140 t, speed up and slow down the rendering of virtual incident representation 140, and the like.

In this manner, the virtual incident representation 140 unfolds in both space and time so that the end user can view one or more of a representation of the current state of the real world incident 101, a representation of a past state of the real world incident 101, a representation of a forecasted future state of the real world incident 101, and the like, as well as various combinations thereof.

The VIRS 106 may be configured to determine an approximate location of the real world incident 101 (e.g., using at least one of a location of a source device 102 from which at least a portion of the incident information 110 is received and at least a portion of the incident information 110) and indicate the approximate location of the real world incident 101 in the virtual incident representation 140 (e.g., via shading, highlighting, one or more icons, and/or any other suitable mechanisms).

The VIRS 106 may be configured, where at least a portion of the incident information is associated with a source device 102, to determine a location of the source device 102 in the real world, determine (e.g., based on the location of the source device 102 in the real world) a virtual location of the source device within the virtual world representation 140, and indicate the virtual location of the source device 102 in the virtual incident representation 140 (e.g., via one or more of an icon, an avatar, text-based information, and/or any other suitable presentation mechanisms). The location of the source device 102 in the real world may be determined using at least one of location tracking information associated with the source device 102 and at least a portion of the incident information 110.

The VIRS 106 may be configured to generate an avatar associated with the real world incident 101 based on at least a portion of the incident information 110 (e.g., an avatar associated with at least one of a person, an object, and a process), determine a virtual location for the avatar within the virtual incident representation 140, and associate the avatar with the determined virtual location for the avatar within the virtual incident representation 140 (e.g., such that the avatar may be displayed at that virtual location within the virtual incident representation 140).

The VIRS 106 may be configured to determine a location of a resource in the real world (e.g., a resource that is configured for use in handling the real world incident 101, such as a resource adapted to respond to real world incident 101, a resource configured to be accessed remotely for obtaining additional incident information 110 for real world incident 101, and the like, as well as various combinations thereof), determine (e.g., based on the location of the resource in the real world) a virtual location of the resource within the virtual world representation 140, and indicate the virtual location of the resource in the virtual incident representation 140 (e.g., via depiction of a particular type of icon/avatar for the resource, via text presented in conjunction with virtual incident representation 140, and the like, as well as various combinations thereof). The location of the source device in the real world may be determined using at least one of location tracking information associated with the resource and at least a portion of the incident information.

The VIRS 106 may be is configured to determine a level of certainty with respect to an item of the incident information 110, and indicate the determined level of certainty within the virtual incident representation 140 (e.g., via use of an appropriate amount of highlighting over a region of the virtual incident representation 140, via use of a particular type of icon and/or an icon having an appropriate amount of detail, via depiction of an appropriate level of detail depicted for an avatar associated with the item of the incident information 110, via a percentage of certainty displayed as text in conjunction with virtual incident representation 140, and the like, as well as various combinations thereof).

The VIRS 106 may be configured to include, within the virtual incident representation 140, information regarding the degree of precision and/or certainty of various types of information included within the virtual incident representation 140. For example, VIRS 106 may be configured to include, of precision and/or certainty of characteristics of people, objects, and/or processes. This may include information regarding the degree of precision/certainty about past characteristics, current characteristics, and/or future/forecasted characteristics. The characteristics may include any types of characteristics for which the degree of precision/certainty may be determined and presented. For example, for a person, the characteristics may include physical characteristics of the person (e.g., gender, race, details of clothing worn, and the like), the location of the person, and the like, as well as various combinations thereof. For example, for an object, the characteristics may include a type of the object, physical characteristics of the object (e.g., address of a building, make/model/color of a car, and the like), the location of the object, and the like, as well as various combinations thereof. For example, for a process, the characteristics may include location of the process, details associated with the process, and the like, as well as various combinations thereof. The VIRS 106 may be configured to dynamically update such information as the degree of precision/certainty changes over time. The system may represent such information within the virtual incident representation 140 in any suitable manner (e.g., via colors, highlighting, text, and the like, as well as various combinations thereof). It is noted that, although primarily depicted and described with respect to embodiments in which VIRS 106 is configured to include information regarding the degree of precision and/or certainty of characteristics of people, objects, and/or processes, VIRS 106 is configured to include information regarding the degree of precision and/or certainty of any other types of information which may be included within or otherwise associated with the virtual incident representation 140 (e.g., information related to source devices 102, supplemental information which may be included within virtual incident representation and/or used to determine information to be included within virtual incident representation, and the like, as well as various combinations thereof).

The VIRS 106 may be configured to enable the end user to zoom in/out of the virtual incident representation 140 for a more/less detailed view of the real world incident 101. This zooming capability may be provided at any suitable granularity (e.g., based on size of the geographic area, based on one or more other factors, and the like, as well as various combinations thereof).

The VIRS 106 may be configured to enable the end user to drill into specific portions of the virtual incident representation 140 in order to obtain information about the specific portions of the virtual incident representation 140. For example, the VIRS 106 may be configured to drill into one or more of people, objects, processes, sources of incident information, and the like, as well as various combinations thereof. For example, where an end user selects a person and drills into the person, the end user may be presented with any relevant information related to that person (e.g., name, physical characteristics, contact information, incident information reported by that person where the person is a member of the public or an emergency responders who provided part of the incident information 110, and the like). For example, where an end user selects an object and drills into the object, the end user may be presented with any information related to that object (e.g., the type of object, physical characteristics of the object, incident information 110 related to the object, and the like). For example, where an end user selects a process and drills into the process, the end user may be presented with any information related to the process (e.g., the type of process, temperature data where the process is a fire, weather conditions in the area where the process is a fire, water depth information where the process is a flood, and the like). For example, where an end user selects a source of incident information and drills into the source of incident information, the end user may be presented with any information related to the source of incident information, such as the type of source, the location of the source, the incident information 110 received from the source (e.g., information, such as text messages, pictures, video feeds, data, and the like, which was supplied by the source in the past or is being supplied by the source in real time), timestamps associated with incident information received from the source, information indicative of the reliability of the source, and the like. In at least some such embodiments in which the information related to the source of incident information is received, the incident information 110 may include time-stamps.

The VIRS 106 may be configured to make various portions of the incident information 110 accessible to the end user. For example, the end user may access voice conversations (e.g., voice conversations between members of the public and emergency operations center operators, voice conversations between emergency responders at the scene of the incident, and the like), voice messages (e.g., voice messages from members of the public reporting information about the incident, voice messages from emergency responders, and the like), text messages, pictures, video, sensor readings, and the like. The end user can access such incident information via an interactive interface of the virtual incident representation 140 and/or independent of the virtual incident representation 140.

The VIRS 106 may be configured to make details regarding the sources of the incident information 110 (e.g., source devices 102) accessible to the end user. For example, as described herein, sources of the incident information 110 may include landline phones, cellular phones, smartphones, laptops, sensors, and the like. For example, details regarding the sources of the incident information 110 accessible to the end user may include information such as the type of the input source (e.g., computer, smartphone, video camera, sensor, and the like), the location of the input source, one or more capabilities of the input source, and the like, as well as various combinations thereof. The end user can access such incident information via an interactive interface of the virtual incident representation 140 and/or independent of the virtual incident representation 140.

The VIRS 106 may be configured to enable end users to initiate communications with objects of interest that are capable of communicating via communication networks. The VIRS 106 may be configured to enable end users to initiate communications with objects of interest via an interactive interface of the virtual incident representation 140 and/or independent of the virtual incident representation 140. For example, an end user can click on an avatar of a person who sent in a text message to report the real world incident 101 in order to send a message to that person asking them a follow-up question. For example, an end user can click on an avatar of an emergency responder at the scene of the real world incident 101 in order to initiate establishment of a voice call with the emergency responder. For example, an end user can click on a representation of a sensor in the virtual incident representation 140 in order to initiate a query for additional information from the sensor. It is noted that various other types of communication may be initiated for various other reasons. In some or all of these cases, the VIRS 106 may ultimately receive additional incident information 110 as a result of these communications, such that the virtual incident representation 140 may be further refined based upon the additional incident information 110.

The VIRS 106 may be configured to enable the end user to interact with the virtual world representation in various other ways. It is noted that the end users may include any users which may access information from VIRS 106. For example, end users may include call center operators handling real world incident 101, emergency responders in the field at the site of real world incident 101, other personnel directly or indirectly involved in handling of the real world incident 101, and the like, as well as various combinations thereof.

As depicted in FIG. 1, virtual incident representation 140 may be used/handled/directed in any suitable manner. For example, the virtual incident representation 140 may be provided to the operator terminal(s) 108 of the safety answering point 105 (e.g., such that it may be viewed by one or more operators working on the real world incident 101). For example, the virtual incident representation 140 may be provided to the responder user device(s) 109 of responders dispatched for on-site handling of the real world incident 101. For example, virtual incident representation 140 may be stored in any suitable manner (e.g., in storage 107 depicted in FIG. 1 and/or in any other suitable storage location). It will be appreciated that virtual world representation 140 may be handled in any other suitable manner (e.g., distributed to other types of end users, transmitted over communication networks for delivery to other systems and/or remote storage, and the like, as well as various combinations thereof).

Although primary depicted and described with respect to embodiments in which the safety answering point to which the real world incident 101 is reported is the only safety answering point responsible for handling the real world incident 101, it is noted that the real world incident 101 may be handled by multiple safety answering points (e.g., in cooperation with each other or operating independently) depending on one or more factors, such as the scope of the real world incident 101, the location of the real world incident 101, the incident type of the real world incident 101, and the like, as well as various combinations thereof. For example, the scope of the real world incident 101 that is handled by the safety answering point may depend on the scope of jurisdiction of the safety answering point, and, thus, may include a portion of the real world incident 101 or all of the real world incident 101 (e.g., the entire incident may be handled by one safety answering point, the entire incident may be handled by multiple safety answering points, the incident may be one of many related incidents handled individually and/or together by one or more safety answering point, and the like).

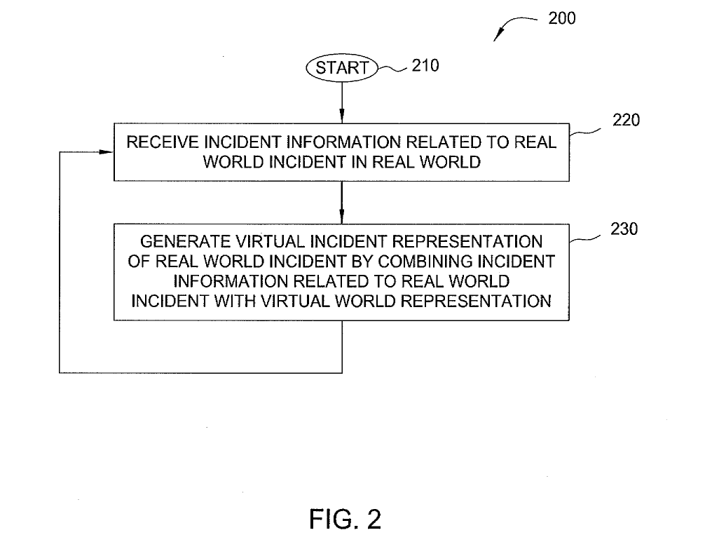

FIG. 2 depicts one embodiment of a method for providing a virtual incident representation of a real world incident. Although primarily depicted and described herein as being performed serially, at least a portion of the steps of method 200 may be performed contemporaneously and/or in a different order than presented in FIG. 2.

At step 210, method 200 begins.

At step 220, incident information related to a real world incident taking place in the real world is received.

At step 230, a virtual incident representation of the real world incident is provided by combining the incident information related to the real world incident with the virtual world representation of the real world. It is noted that providing of the virtual incident representation may include initial generation of the virtual incident representation based on at least a portion of the incident information, updating of an existing virtual incident representation based on at least a portion of the incident information, and the like From step 230, method 200 returns to step 220, such that the virtual incident representation of the real world incident is updated over time as more incident information related to the real world incident is received.

Although not addicted and described as ending, it is noted that method 200 may end at any suitable time (e.g., in response to an operator of the safety answering point indicating that handling of the real world incident is complete such that real time access to the virtual incident representation is no longer required or in response to any other suitable event or condition).

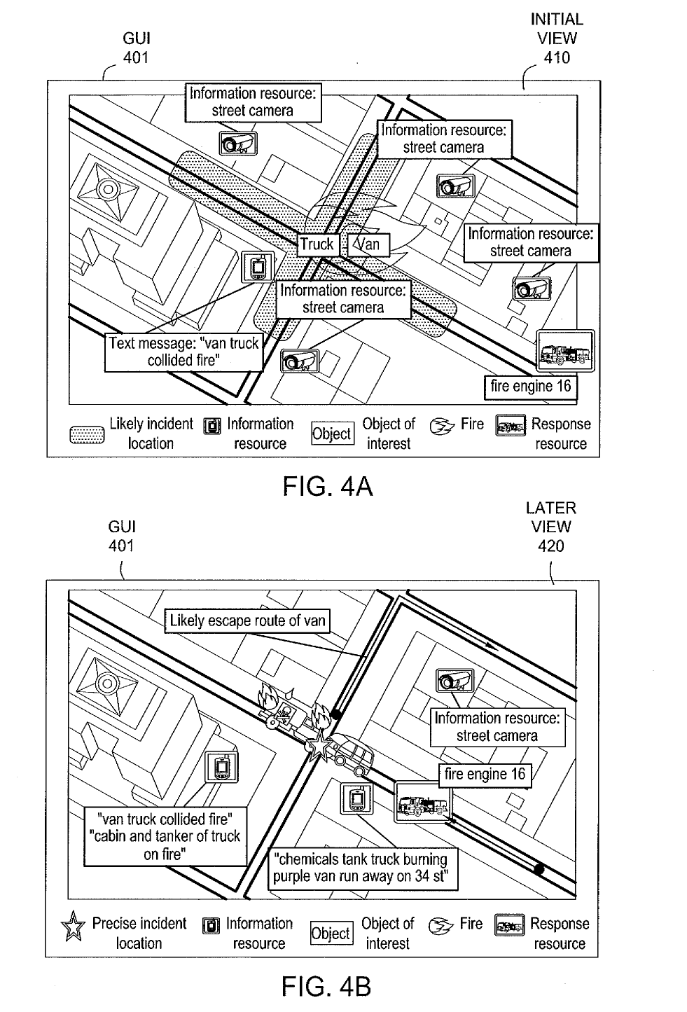

It is noted that the steps of method 200 may be better understood when considered in conjunction with FIG. 1 and FIGS. 4A/4B.

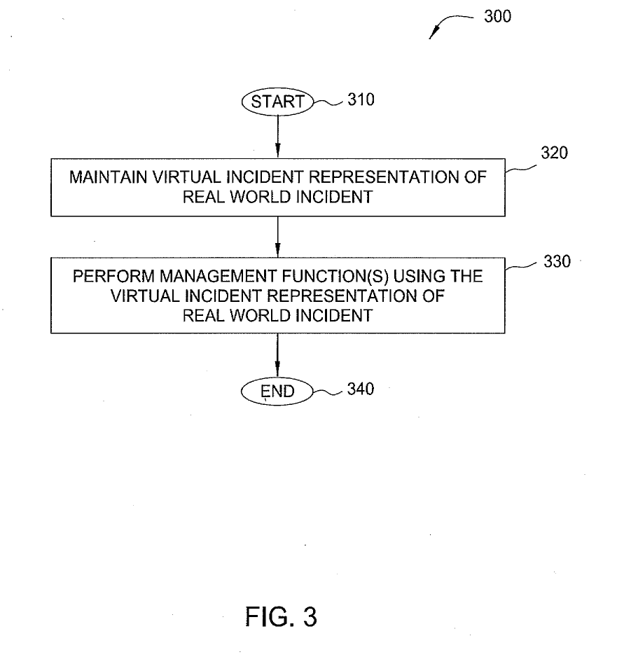

FIG. 3 depicts one embodiment of a method for using a virtual incident representation of a real world incident to perform one or more management functions. Although primarily depicted and described herein as being performed serially, at least a portion of the steps of method 300 may be performed contemporaneously and/or in a different order than presented in FIG. 3.

At step 310, method 300 begins.

At step 320, a virtual incident representation of a real world incident is maintained. In one embodiment, the virtual incident representation of the real world incident is maintained using method 200 of FIG. 2.

At step 330, the virtual incident representation of the real world incident is used to perform one or more management functions. For example, the management functions may include presenting the virtual incident representation to one or more operators via one or more operator terminals of the safety answering point, providing the virtual incident representation to one or more responders for use in planning actions to be taken upon arriving at the site of the real world incident and/or for use in responding to the real world incident when at the site of the real world incident, providing the virtual incident representation to other personnel who may be involved in handling aspects of the real world incident, and the like, as well as various combinations thereof.

At step 340, method 300 ends. Although depicted and described as ending (for purposes of clarity), it is noted that method 300 may continue to be repeated for as long as necessary or desired in order to facilitate handling of the real world incident.

It is noted that the steps of method 300 may be better understood when considered in conjunction with FIGS. 1 and 4A/4B.

FIGS. 4A and 4B depict an example illustrating an initial virtual incident representation and modification of the initial virtual incident representation over time to provide thereby a later virtual incident representation.

As depicted in FIGS. 4A and 4B, a virtual incident representation of a real world incident is presented via a graphical user interface 401 displayed via a display interface (which is omitted for purposes of clarity). More specifically, FIG. 4A depicts an initial view 410 of the virtual incident representation that is formed based on a first set of incident information that is received for the real world incident and FIG. 4B depicts a later view 420 of the virtual incident representation that is formed based on a second set of incident information that is received for the real world incident. For example, the initial view 410 and later view 420 of the virtual incident representation may be presented to an operator via an operator terminal at the safety answering point, may be presented to a responder via an end user terminal of the responder, and the like.

A description of the real world incident, reporting of information for the real world incident, and associated generation and modification of the virtual incident representation based on the incident information follows.

As depicted in FIGS. 4A and 4B, the real world incident is a collision between a truck and a van, on 5^{th} Avenue near 34^{th} Street in New York City, which causes the truck to catch on fire.

As depicted in FIG. 4A, the initial view 410 of the virtual incident representation is generated for the real world incident based on initial incident information received when the real world incident is reported. For example, upon witnessing the collision, a nearby citizen sends the following text message to a safety answering point (e.g., an E911 center) using his or her cellular phone: “van truck collided fire 5 av 34”. The initial view 410 of the virtual incident representation is generated based on information associated with the received text message. It is noted that the initial view 410 of the virtual incident representation merely represents a snapshot of the virtual incident representation as the virtual incident representation may be change incrementally over time as more information is received/details are determined.

The initial view 410 of the virtual incident representation depicts details of the virtual world representation (illustratively, buildings, streets, and other details of interest).

The initial view 410 of the virtual incident representation also depicts an approximate location of the cellular phone from which the text message was received.

The initial view 410 of the virtual incident representation also depicts avatars for the truck and the van, respectively. It is noted that the avatars for the truck and the van are quite generic in the initial view 410 of the virtual incident representation (illustratively, as rectangles including the words “truck” and “van”, respectively), since no information about these vehicle is available at this point in time.

The initial view 410 of the virtual incident representation also depicts an estimated geographic area in which the accident may have occurred, including an indication as to the degree of certainty of the estimated geographic area. It is noted that the estimated geographic area and its associated degree of certainty information may be determined based on one or more of the location of the cellular phone from which the text message was received, information about the incident which is included within the text message, data about the physical location of the general area in which the incident occurred, data about the type of incident reported, and the like, as well as various combinations thereof. For example, the estimated area of the incident may be determined based on the following information/processing: (1) a determination that a collision between a truck and a van is likely to have taken place on a street, rather than inside the footprint of a non-garage building, and (2) a determination that, since the cellular phone from which the text message was sent is located on 5^{th} Avenue near 34^{th} Street (e.g., as determined from GPS data associated with the cellular phone), the portion of the text message which states “5 av 34” probably refers to the area near the intersection of 5^{th} Avenue and 34^{th} Street.

The initial view 410 of the virtual incident representation also depicts the types and locations of additional resources that the emergency operator can deploy and/or use (illustratively, a fire truck that can be dispatched to the scene to put out the fire and city cameras that can be accessed remotely in order to get video of the scene of the incident).

The initial view 410 of the virtual incident representation also includes a legend defining various icons, avatars, and other graphics depicted as part of the initial view 410 of the virtual incident representation. For example, the legend indicates a type of highlighting used to identify the likely location of the real world incident (identifying portions of 5^{th} Avenue and 34^{th} Street that are extending in both directions from the intersection of 5^{th} Avenue and 34^{th} Street). For example the legend includes an exemplary type of graphical highlighting used to identify information resources displayed as part of the initial view 410 of the virtual incident representation (illustratively, two boxes around a symbol indicative of the type of information resource, such as a phone icon for a phone, a video camera icon for a video camera, and the like). For example, the legend includes an exemplary type of graphical highlighting used to identify generic objects of interest which are displayed as part of the initial view 410 of the virtual incident representation (illustratively, a single box including a word(s) identifying the type of object, such as the rectangles which include the words “truck” and “van). For example, the legend includes an exemplary icon which is used to represent a location(s) of a fire(s) at the site of the real world incident (illustratively, depicted as covering a relatively large geographic area due to the lack of specificity regarding the number of fires burning the their precise locations). For example, the legend includes an exemplary icon which may be used to represent a particular type of response resource dispatched to the site of the real world incident (illustratively, a fire truck). It will be appreciated that the legend, which also may be omitted from the initial view 410 of the virtual incident representation, may include less or more information, may include different types of information, may be arranged at a different position on the graphical display, and the like, as well as various combinations thereof.

The initial view 410 of the virtual incident representation is interactive, thereby enabling the emergency operator to select the various resources represented in the initial view 410 of the virtual incident representation in order to perform various functions. For example, the emergency operator can click on the cellular phone in order to request additional information from the cellular phone, click on the video cameras to request video captured by the video cameras, click on the fire truck to initiate voice communications with the firefighters in the fire truck, and the like.

As depicted in FIG. 4B, the later view 420 of the virtual incident representation is provided for the real world incident. It is noted that the later view 420 of the virtual incident representation merely represents a snapshot of the virtual incident representation as the virtual incident representation may be change incrementally over time as more information is received/details are determined.

As depicted in FIG. 4B, the later view 420 of the virtual incident representation is provided for the real world incident based on changing conditions of the real world incident.

In one embodiment, for example, as the events of the real world incident unfold, the various objects of interest may move, and the movements are reflected in the later view 420 of the virtual incident representation. For example, as additional incident information is received, the virtual incident representation becomes more precise (as represented in the later view 420 of the virtual incident representation). For example, as messages, photographs, and videos are received from source devices at or near the scene of the real world incident, the location of the real world incident becomes more precisely specified, the location and magnitude of the fires become more precisely specified, the avatars of the objects of interest (e.g., the van and the truck) become more detailed (e.g., more representative of the actual vehicles involved, such as in terms of vehicle color, make, model, and the like), and the like, as well as various combinations thereof.

In one embodiment, for example, as the events of the real world incident unfold, the objects of interest may move and, in addition to reflecting the movements in the later view 420 of the virtual incident representation, the likely future trajectory of the objects may be forecasted. For example, if a determination is made that the van is leaving the scene of the incident, the likely trajectory of the van may be determined based on its motion, the layout of the streets, the traffic situation, the timing of the traffic signals, and the like, as well as various combinations thereof. The forecasted trajectories of the objects may be depicted directly on the virtual incident representation and/or accessed via the virtual incident representation.

The later view 420 of the virtual incident representation, like the initial view 410 of the virtual incident representation, also includes a legend defining various icons, avatars, and other graphics depicted as part of the later view 420 of the virtual incident representation. For example, the legend an icon used to identify the location of the real world incident. For example the legend includes an exemplary type of graphical highlighting used to identify information resources displayed as part of the initial view 410 of the virtual incident representation (illustratively, two boxes around a symbol indicative of the type of information resource, such as a phone icon for a phone, a video camera icon for a video camera, and the like). For example, the legend includes an exemplary type of graphical highlighting used to identify generic objects of interest which are displayed as part of the initial view 410 of the virtual incident representation. For example, the legend includes an exemplary icon which is used to represent the locations of fires at the site of the real world incident (illustratively, depicted as smaller icons at specific locations at the site of the real world incident, where, for each fire, the size of the depicted fire icon is indicative of the size of the associated fire). For example, the legend includes an exemplary icon which may be used to represent a particular type of response resource dispatched to the site of the real world incident (illustratively, a fire truck). It will be appreciated that the legend, which also may be omitted from the later view 420 of the virtual incident representation, may include less or more information, may include different types of information, may be arranged at a different position on the graphical display, and the like, as well as various combinations thereof.

In this manner, the real world incident is represented using a dynamic virtual world representation that unfolds in space and time. For example, in the case of both initial view 410 and later view 420 of the virtual incident representation, an end user can interact with the virtual representation in a variety of ways, e.g., initiating “play back” of the real world incident via the virtual incident representation in order to see how the real world incident has unfolded over a period of time, initiating “play forward” of the real world incident via the virtual incident representation in order to see the forecasted movement of the objects of interest in the future, drilling down into detail of various people, objects, and/or processes represented in the virtual incident representation, selecting people and/or objects in order to initiate contact with the people/objects if they are people/objects capable of being contacted (e.g., requesting video from a video camera, initiating a phone call with a cellular phone of a witness who provided information related to the real world incident, requesting data from a sensor, and the like), and the like, as well as various combinations thereof).

In one embodiment, the view of the virtual incident representation that is presented to an end user and/or the ability of the end user to interact with the virtual incident representation (e.g., to drill down into details of the virtual incident representation, to initiate contact with various people and/or objects on the scene of the real world incident, and the like) may depend on one or more factors (e.g., the user type of the end user, an authorization level of the end user, privacy and/or other policies or regulations applicable to the end user and/or to the real world incident, and the like, as well as various combinations thereof). For example, the view of the virtual incident representation that is presented to an end user may only include a subset of the information included within the full virtual incident representation (e.g., only the information that the end user is authorized to review, only the information that is pertinent to the job to be performed by the end user, and the like). For example, the view of the virtual incident representation that is presented to a responder may be different than the view of the virtual incident representation that is presented to an emergency operator at a emergency call center, e.g., to accommodate the job requirements of the responder, the location of the responder (e.g., if the responder is at the location of the real world incident, the virtual incident representation may be superimposed on an actual picture of the location rather than using a 3D simulation of the location), the current situation at the real world incident, the type of mobile device on which the virtual incident representation will be presented, and the like, as well as various combinations thereof.

It is noted that the example of FIGS. 4A and 4B is merely one example of a specific type of incident for which a virtual incident representation may be provided. It will be appreciated that virtual incident representations may be provided for various other types of real world incidents and further that, for at least some such real world incidents, the virtual incident representations may be provided in other ways (e.g., using different types of icons, avatars, highlighting, legends, and the like, as well as various combinations thereof).

It will be appreciated that various embodiments of the virtual incident representation capability reduce the cognitive load on people associated with handling of incidents (e.g., emergency operators at the safety answering point, responders in the field, and the like). For example, instead of having to look at various types of information about an incident on separate windows and/or screens, and having to integrate this information into a single coherent story in his or her head, an emergency operator is presented with an integrated virtual representation of the information available about the incident in a manner that answers the natural human questions arising from such an incident (e.g., What? Where? When? Who? and Why?) by “re-enacting the story of the incident” in space and in time. Similarly, for example, instead of having to synthesize such information in his or her head on the way to the incident and/or upon arriving at the site of the incident, a responder in the field is presented (e.g., on a single mobile device carried by the responder) with an integrated virtual representation of the information available about the incident in a manner that answers the natural human questions arising from such an incident (e.g., what, where, when, who, and why) by “re-enacting the story of the incident” in space and in time.

It is noted that various embodiments of the virtual incident representation capability enable presentation and storage of virtual incident representations in a manner facilitating later use of the virtual incident representations for purpose of planning, training, and/or investigation.

Although primarily depicted and described herein within the context of providing embodiments of the virtual incident representation capability within a specific type of environment (illustratively, within an environment of a Public Safety Answering Point, such as an E911 system), it is noted that embodiments of the virtual incident representation capability also may be used in various other types of environments (e.g., environments related to corporate/academic campus security, security in retail establishments, security in government installations, security in transportation facilities (e.g., ports, airports, and the like), and the like, as well as various combinations thereof). In this sense, it will be appreciated that various embodiments and associated examples provided herein also are applicable to any other type of environment which may benefit from a variety of potentially pertinent information about incidents (e.g., audio, text, pictures, video, location data, sensor data, and the like) that may be available from various sources of such pertinent information.

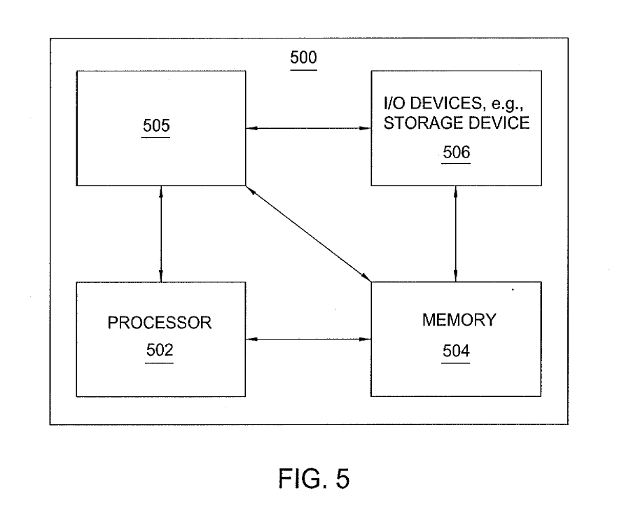

FIG. 5 depicts a high-level block diagram of a computer suitable for use in performing functions described herein.

As depicted in FIG. 5, computer 500 includes a processor element 502 (e.g., a central processing unit (CPU) and/or other suitable processor(s)) and a memory 504 (e.g., random access memory (RAM), read only memory (ROM), and the like). The computer 500 also may include a cooperating module/process 505 and/or various input/output devices 506 (e.g., a user input device (such as a keyboard, a keypad, a mouse, and the like), a user output device (such as a display, a speaker, and the like), an input port, an output port, a receiver, a transmitter, and storage devices (e.g., a tape drive, a floppy drive, a hard disk drive, a compact disk drive, and the like)).

It will be appreciated that the functions depicted and described herein may be implemented in software (e.g., via implementation of software on one or more processors) and/or may be implemented in hardware (e.g., using a general purpose computer, one or more application specific integrated circuits (ASIC), and/or any other hardware equivalents).

It will be appreciated that the functions depicted and described herein may be implemented in software (e.g., for executing on a general purpose computer (e.g., via execution by one or more processors) so as to implement a special purpose computer) and/or may be implemented in hardware (e.g., using one or more application specific integrated circuits (ASIC) and/or one or more other hardware equivalents).

In one embodiment, the cooperating process 505 can be loaded into memory 504 and executed by the processor 502 to implement functions as discussed herein. Thus, cooperating process 505 (including associated data structures) can be stored on a computer readable storage medium, e.g., RAM memory, magnetic or optical drive or diskette, and the like.

It will be appreciated that computer 500 depicted in FIG. 5 provides a general architecture and functionality suitable for implementing functional elements described herein and/or portions of functional elements described herein. For example, the computer 500 provides a general architecture and functionality suitable for implementing one or more of a source device 102 associated with incident information 110, VIRS 106, an operator terminal 108, a responder user device 109, and the like.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal bearing medium, and/or stored within a memory within a computing device operating according to the instructions.

Although various embodiments which incorporate the teachings of the present invention have been shown and described in detail herein, those skilled in the art can readily devise many other varied embodiments that still incorporate these teachings.

What is claimed is:

1. An apparatus, comprising:
a processor and a memory, the processor configured to:
receive incident information related to a real world incident and directed toward a safety answering point, wherein the incident information comprises a plurality of information types; and
combine the incident information with a virtual representation of a portion of the real world associated with a location of the real world incident to provide thereby a virtual incident representation of the real world incident.

2. The apparatus of claim 1, wherein the processor is configured to:
determine an approximate location of the real world incident; and
indicate the approximate location of the real world incident in the virtual incident representation.

3. The apparatus of claim 2, wherein the approximate location of the real world incident is determined using at least one of a location of a source device from which at least a portion of the incident information is received and at least a portion of the incident information.

4. The apparatus of claim 1, wherein a portion of the incident information is received from a source device, wherein the processor is configured to generate the virtual incident representation by:
determining a location of the source device in the real world;
determining, based on the location of the source device in the real world, a virtual location of the source device within the virtual world representation; and
indicating the virtual location of the source device in the virtual incident representation.

5. The apparatus of claim 4, wherein the location of the source device in the real world is determined using at least one of location tracking information associated with the source device and at least a portion of the incident information.

6. The apparatus of claim 1, wherein the processor is configured to:
generate an avatar associated with the real world incident based on at least a portion of the incident information;
determine a virtual location for the avatar within the virtual incident representation; and
associate the avatar with the determined virtual location for the avatar within the virtual incident representation.

7. The apparatus of claim 6, wherein the avatar is configured to represent one of a person, an object, and a process.

8. The apparatus of claim 1, wherein the processor is configured to:
determine a level of certainty with respect to an item of the incident information; and
indicate the determined level of certainty within the virtual incident representation.

9. The apparatus of claim 8, wherein the level of certainty is indicated using a level of detail depicted for an avatar associated with the item of the incident information.

10. The apparatus of claim 1, wherein the processor is configured to:
determine a location of a resource in the real world, wherein the resources is configured for use in handling the real world incident;
determine, based on the location of the resource in the real world, a virtual location of the resource within the virtual world representation; and
indicate the virtual location of the resource in the virtual incident representation.

11. The apparatus of claim 10, wherein the resource is a resource adapted to respond to the real world incident or a resource configured to be accessed remotely for obtaining additional incident information associated with the real world incident.

12. The apparatus of claim 1, wherein the processor is configured to create a snapshot of the virtual incident representation of the real world incident at a particular point in time.

13. The apparatus of claim 12, wherein the particular point in time is one of a time in the past and a time in the future.

14. The apparatus of claim 1, wherein the processor is configured to create a video of the virtual incident representation of the real world incident over a particular range of time.

15. The apparatus of claim 14, wherein the particular range of time includes at least one of a range of time in the past and a range of time in the future.

16. The apparatus of claim 1, wherein the processor is configured to:
predict a future state of the virtual incident representation of the real world incident.

17. The apparatus of claim 1, wherein the processor is configured to perform at least one of:
storing the virtual incident representation of the real world incident in at least one storage device;
propagating the virtual incident representation of the real world incident toward a display device of the safety answering point; and
propagating the virtual incident representation of the real world incident toward an end user device of a responder associated with the real world incident.

18. The apparatus of claim 1, wherein the processor is configured to:
determine a user type of an end user requesting access to the virtual incident representation; and
select, based on the user type of the end user, a portion of the virtual incident representation for presentation to the end user.

19. A computer-readable storage medium storing instructions which, when executed by a computer, cause the computer to perform a method, the method comprising:
receiving incident information related to a real world incident and directed toward a safety answering point, wherein the incident information comprises a plurality of information types; and
combining the incident information with a virtual representation of a portion of the real world associated with a location of the real world incident to provide thereby a virtual incident representation of the real world incident.

20. A method, comprising:
using a processor and a memory for:
receiving incident information related to a real world incident and directed toward a safety answering point, wherein the incident information comprises a plurality of information types; and
combining the incident information with a virtual representation of a portion of the real world associated with a location of the real world incident to provide thereby a virtual incident representation of the real world incident.
